(19) United States
(12) Patent Application Publication
(10) Pub. No.: US 2024/0063860 A1
(43) Pub. Date: Feb. 22, 2024

(54) Communication Method and Communication Device

(71) Applicant: MEDIATEK INC., Hsin-Chu (TW)

(72) Inventors: Wei-Yi Wang, Hsinchu City (TW); Dung-Rung Shie, Hsinchu City (TW); Nien-En Wu, Hsinchu City (TW)

(73) Assignee: MEDIATEK INC., Hsin-Chu (TW)

(21) Appl. No.: 18/229,156

(22) Filed: Aug. 1, 2023

Related U.S. Application Data
(60) Provisional application No. 63/371,772, filed on Aug. 18, 2022.

(51) Int. Cl. H04B 7/06; H04B 7/0413

(52) U.S. Cl. CPC H04B 7/0608; H04B 7/0413

(57) ABSTRACT

A communication method includes generating, by a processor of a communication device having a plurality of antennas, an antenna selection information; determining, by the processor, first antennas to be used for a transmission with a network within the plurality of antennas according to the antenna selection information; and performing, by the processor, the transmission with the network through the first antennas.

### CROSS REFERENCE TO RELATED APPLICATIONS

This application claims the benefit of U.S. Provisional Application No. 63/371,772, filed on Aug. 18, 2022. The content of the application is incorporated herein by reference.

### BACKGROUND

In a wireless communication system, such as long-term evolution (LTE) system and LTE-advanced (LTE-A) system, the physical downlink shared channel (PDSCH) is a channel that carries user data in the downlink direction. The PDSCH can be transmitted over multiple layers, each of which corresponds to one antenna port. However, the number of layers may not match the number of antennas available in a communication device. For example, a device may have four antennas, but only receive two layers of PDSCH. In this case, the unused antennas can provide some diversity gain, but they also increase the power consumption of the device. Moreover, the downlink traffic of the device is often low in daily scenarios, so using more antennas than necessary may not be efficient. Therefore, it is desirable to design methods to dynamically adjust the number of antennas used for PDSCH transmission according to the traffic demand and channel conditions, so as to save power and improve performance.

### SUMMARY

Therefore, the purpose of the present invention is to provide a communication method and related communication device to improve the drawback of the prior art.

The embodiment of the present invention discloses a communication method, comprising generating, by a processor of a communication device having a plurality of antennas, an antenna selection information; determining, by the processor, first antennas to be used for a transmission with a network within the plurality of antennas according to the antenna selection information; and performing, by the processor, the transmission with the network through the first antennas.

The embodiment of the present invention discloses a communication device, comprising a plurality of antennas; and a storage device, configured to store instructions of generating an antenna selection information; determining first antennas to be used for a transmission with a network within the plurality of antennas according to the antenna selection information; and performing the transmission with the network through the first antennas; and a processor, coupled to the plurality of antennas and the storage device, configured to execute the instructions stored in the storage device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a communication system according to an embodiment of the present invention.

FIG. 2 is a flowchart of the communication method according to an embodiment of the present invention.

FIG. 3 is a flowchart of the communication method according to another embodiment of the present invention.

### DETAILED DESCRIPTION

Certain terms are used throughout the description and following claims to refer to particular components. As one skilled in the art will appreciate, hardware manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to”. “Approximately” means that within the acceptable error range, a person with ordinary knowledge in the field can solve the technical problem within a certain error range and basically achieve the technical effect. Also, the term “couple” is intended to mean either an indirect or direct, wired or wireless electrical connection.

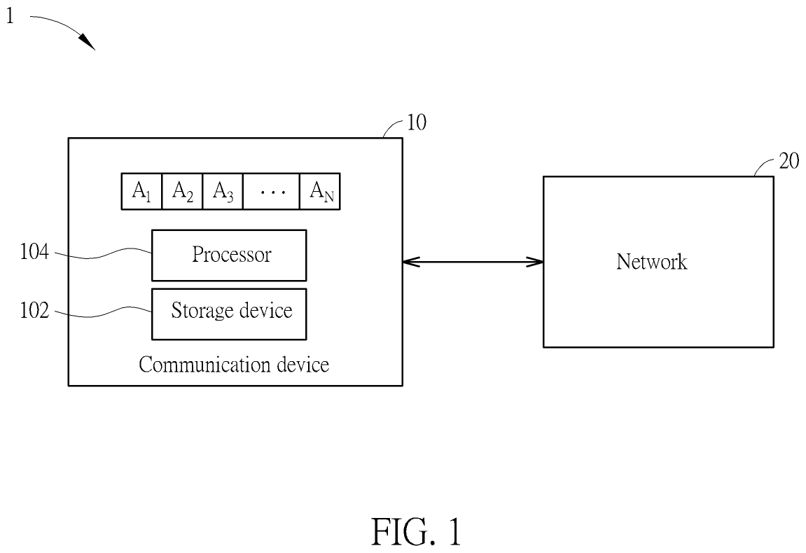

Please refer to FIG. 1. FIG. 1 is a schematic diagram of a communication system 1 according to an embodiment of the present invention. The communication system 1 includes a communication device 10 and a network 20.

The network 20 and the communication device 10 are simply utilized for illustrating the structure of the wireless communication system 1. Practically, the network 20 may be a universal terrestrial radio access network (UTRAN) including at least one Node-B (NB) in a universal mobile telecommunications system (UMTS). In one example, the network 20 may be an evolved UTRAN (E-UTRAN) including at least one evolved NB (eNB) and/or at least one relay node in a long term evolution (LTE) system, a LTE-Advanced (LTE-A) system, an evolution of the LTE-A system, etc. In one example, the network 20 may be a next generation radio access network (NG-RAN) including at least one next generation Node-B (gNB) and/or at least one fifth generation (5G) base station (BS). In one example, the network 20 may be any BS conforming to a specific communication standard to communicate with the communication device 10.

Furthermore, the network 20 may also include at least one of the UTRAN/E-UTRAN/NG-RAN and a core network, wherein the core network may include network entities such as Mobility Management Entity (MME), Serving Gateway (S-GW), Packet Data Network (PDN) Gateway (P-GW), Self-Organizing Networks (SON) server and/or Radio Network Controller (RNC), etc. In one example, after the network 20 receives information transmitted by the communication device 10, the information may be processed only by the UTRAN/E-UTRAN/NG-RAN and decisions corresponding to the information are made at the UTRAN/E-UTRAN/NG-RAN. In one example, the UTRAN/E-UTRAN/NG-RAN may forward the information to the core network, and the decisions corresponding to the information are made at the core network after the core network processes the information. In one example, the information may be processed by both the UTRAN/E-UTRAN/NG-RAN and the core network, and the decisions are made after coordination and/or cooperation are performed by the UTRAN/E-UTRAN/NG-RAN and the core network.

The communication device 10 may be a user equipment (UE), a low cost device (e.g., machine type communication (MTC) device), a device-to-device (D2D) communication device, a narrow-band internet of things (IoT) (NB-IoT), a mobile phone, a laptop, a tablet computer, an electronic book, a portable computer system, or combination thereof. In addition, the network 20 and the communication device 10 can be seen as a transmitter or a receiver according to direction (i.e., transmission direction), e.g., for an uplink (UL), the communication device 10 is the transmitter and the network 20 is the receiver, and for a downlink (DL), the network 20 is the transmitter and the communication device 10 is the receiver, which may be a user equipment (UE), Specifically, the communication device 10 includes a plurality of antennas A₁-A_{N}, a storage device 102 and a processor 104. The plurality of antennas A₁-A_{N} and the storage device 102 are coupled to the processor 104, which are used to represent basic components of the communication device 10, but are not limited thereto. The storage device 102 stores instructions for instructing the processor 104 to execute a communication method, so that the communication device 10 performs a transmission with the network 20 through one or more antennas within the plurality of antennas A₁-A_{N}.

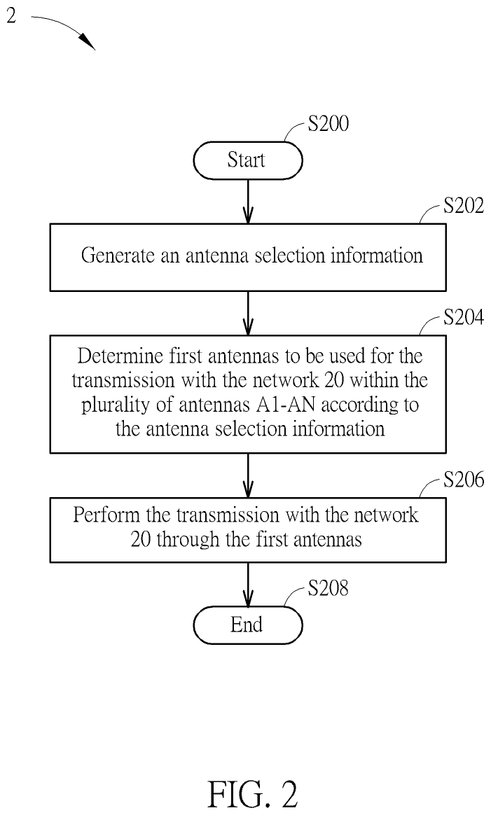

The communication method of the communication device 10 may be summarized into a process 2, as shown in FIG. 2. The process 2 includes the following steps:

Step S200: Start.

Step S202: Generate an antenna selection information.

Step S204: Determine first antennas to be used for the transmission with the network 20 within the plurality of antennas A₁-A_{N} according to the antenna selection information.

Step S206: Perform the transmission with the network 20 through the first antennas.

Step 208: End.

According to the process 2, in step S202, the communication device 10 generates the antenna selection information. Specifically, the antenna selection information may include a high-layer configuration, a low-layer report and a non-modem information, etc., and not limited thereto. For example, the non-modem information may be information detected by sensors or a gyroscope of the communication device 10 or the network 20 for determining whether the communication device 10 is in an idle state or what operations the communication device 10 is processing. As another example, the communication device 10 may receive the high-layer configuration, e.g. a maxLayersMIMO or a transmission mode information form the network 20. For another example, the communication device 10 may generate the low-layer report, e.g. a signal-to-noise ratio (SNR), a reference signal received power (RSRP), a block error rate (BLER) or a mutual information (MI), according to signals receiving from the network 20. It should be noted that the antenna selection information may also be collected by detecting scenarios between the communication device 10 and the network 20. For example, the scenarios may refer to whether there is a physical downlink shared channel (PDSCH) transmission, a PDSCH duty ratio, a PDSCH layer number or a modulation coding scheme (MCS). In particular, the scenarios may refer to a voice over new radio (VoNR).

In steps S204 and S206, the communication device 10 determines the first antennas to be used for the transmission with the network 20 within the plurality of antennas A₁-A_{N} according to the antenna selection information. Then, the communication device 10 performs the transmission with the network 20 through the first antennas. Specifically, the communication device 10 may adaptively adjust or reduce a number of the first antennas by processing the communication method, so as to reduce power consumption or enhance communication performance and efficiency of the communication device 10.

The present invention proposes several embodiments for adaptively adjusting or reducing the number of the first antennas for transmission.

In an embodiment, the antenna selection information may include a first layer number of the PDSCH. The communication device 10 compares the first layer number of the PDSCH with an antenna number of the first antennas. In an event that the antenna number of the first antennas is equal to the first layer number of the PDSCH, the communication device 10 maintains the antenna number of the first antennas. In an event that the antenna number of the first antennas is greater than the first layer number of the PDSCH, the communication device 10 decreases the antenna number of the first antennas. Accordingly, the communication device 10 may avoid using unnecessary antennas and perform the transmission through fewer first antennas, so as to reduce the power consumption. In an example, the communication device 10 has four antennas, and PDSCH established with the network 20 has only two layers. According to the process 2, the communication device 10 may determine the antenna number of the first antennas to be 2 or 3. In this way, compared with using four antennas for the transmission, the power consumption of the communication device 10 using 2 or 3 antennas may be reduced.

In another embodiment, the antenna selection information may include a second layer number of downlink (DL) maxLayersMIMO. The communication device 10 compares the second layer number of the DL maxLayersMIMO with a receiver capability. In an event that the second layer number of the DL maxLayersMIMO is smaller than the receiver capability, the communication device 10 decreases the antenna number of the first antennas. In an event that the second layer number of the DL maxLayersMIMO is not smaller than the receiver capability, the communication device 10 requests the network to decrease the second layer number of the DL maxLayersMIMO to be smaller than the receiver capability. Accordingly, the communication device 10 may avoid using unnecessary antennas and perform the transmission through fewer first antennas, so as to reduce the power consumption. The communication device 10 may report fake rank indicator (RI) even when the channel quality is good enough for higher value. And it is expected for the network 20 to reduce the first layer number of the PDSCH layer so as to reduce the power consumption of the communication device 10. It should be noted that, in 3^{rd} Generation Partnership Project (3GPP) New Radio (NR) Release-16, a UE-assisted information (UAI) is introduced to allow the communication device 10 to provide the assistance information to the network 20. For example, the communication device 10 may report MaxMIMO-LayerPreference-r16 and expect the network 20 to decrease the second layer number of the DL maxLayersMIMO to be smaller than the receiver capability through sending the UAI to the network.

In another embodiment, the antenna selection information may include a PDCCH (physical downlink control channel)-only ratio and an average PHY throughput. The communication device 10 determines whether the communication device 10 is in a light traffic state according to the PDCCH-only ratio and the average PHY throughput during a period of time. In an event that the communication device 10 is not in the light traffic state, the communication device 10 maintains or increases the antenna number of the first antennas. In an event that the communication device 10 is in the light traffic state, the communication device 10 decreases the antenna number of the first antennas. Accordingly, the communication device 10 may avoid using unnecessary antennas and perform the transmission through fewer first antennas, so as to reduce the power consumption. In an example, in an event that the PDCCH-only ratio is greater than a first threshold and the average PHY throughput is smaller than a second threshold, the communication device 10 is in a light traffic state, so that the communication device 10 decreases the antenna number of the first antennas for the transmission with the network 20.

In another embodiment, the antenna selection information may include at least one signal quality indicator, such as SNR, RSRP, BLER, MI, etc., of the communication device. The communication device 10 determines whether the at least one signal quality indicator is in a poor state. In an event that the at least one signal quality of the communication device is in the poor state, the communication device 10 maintains or increases the antenna number of the first antennas. In an event that the at least one signal quality of the communication device is not in the poor state, the communication device 10 decreases the antenna number of the first antennas. Accordingly, the communication device 10 may avoid using unnecessary antennas and perform the transmission through fewer first antennas, so as to reduce the power consumption.

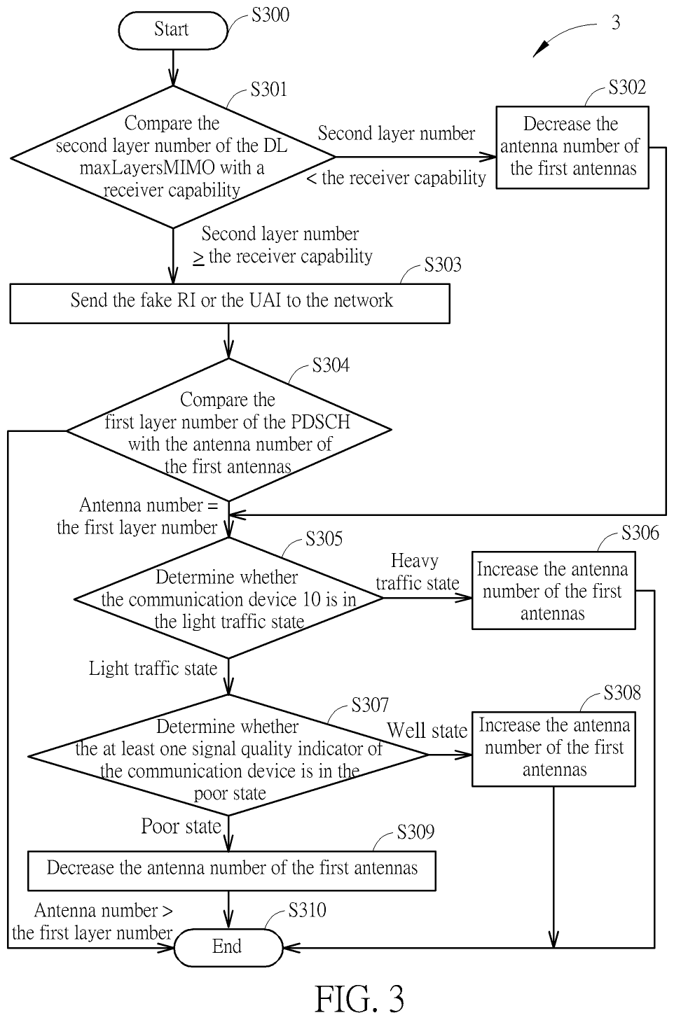

It should be noted that the above-mentioned embodiments are different embodiments of the present invention. Those skilled in the art should readily make combinations, modifications and/or alterations on the abovementioned description and examples. For example, the communication method of the communication device 10 may be realized by the combination of the above-mentioned embodiments and summarized as a process 3, as shown in FIG. 3. The process 3 includes the following steps:

Step S300: Start.

Step S301: Compare the second layer number of the DL maxLayersMIMO with a receiver capability. If the second layer number of the DL maxLayersMIMO is smaller than a receiver capability, proceed to step S302; otherwise, proceed to step S303.

Step S302: Decrease the antenna number of the first antennas.

Step S303: Request the network to decrease the second layer number of the DL maxLayersMIMO to be smaller than the receiver capability.

Step S304: Compare the first layer number of the PDSCH with the antenna number of the first antennas. If the first layer number of the PDSCH is smaller than the antenna number of the first antennas, proceed to step S310; otherwise, proceed to step S305.

Step S305: Determine whether the communication device 10 is in the light traffic state. If the communication device 10 is in the light traffic state, proceed to step S307; otherwise, proceed to step S306.

Step S306: Increase the antenna number of the first antennas.

Step S307: Determine whether the at least one signal quality indicator of the communication device is in the poor state. If the at least one signal quality indicator of the communication device is in the poor state, proceed to step S309, otherwise, proceed to step S308.

Step S308: Increase the antenna number of the first antennas.

Step S309: Decrease the antenna number of the first antennas.

Step 310: End.

The detailed description of the process 3 is as described above, and will not be repeated here. For the selection of the first antennas under various antenna selection information, please refer to Table 1. As shown in Table 1, assume the receiver capability is 2RX, in the scenario where the SNR is equal to 30 dB and the PDSCH adopts 256-QAM modulation method, such as scenario 1, the network 20 sets the DL maxMIMOlayer equal to 2 and sends 2-layer PDSCH on every slot to the communication device 10. In scenario 1, the communication device 10 performs the transmission with the network 20 through two first antennas. In another scenario where the SNR is equal to 0 dB and the PDSCH adopts 256-QAM modulation method, such as scenario 8, the network 20 sets the DL maxMIMOlayer equal to 1 and sends 1-layer PDSCH on every slot to the communication device 10. In scenario 8, the communication device 10 performs the transmission with the network 20 through two first antennas. For the sake of brevity, other scenarios are not described here.

TABLE 1

| | | | |
|---|---|---|---|
| | DL | | Antenna |
| Scenario | maxMIMOlayer | PDSCH | number |

SNR = 30 dB, PDSCH 256QAM

| | | | |
|---|---|---|---|
| 1 | 2 | 2 layers PDSCH on every | 2 |
| | | slot | |
| 2 | 1 | 1 layers PDSCH on every | 1 |
| | | slot | |
| 3 | 2 | 1 layers PDSCH on every | 1 |
| | | slot | |
| 4 | 2 | no layer PDSCH on every | 1 |
| | | slot | |
| 5 | 2 | 1 layers PDSCH on 10% | 1 |
| | | of the slot | |
| 6 | 2 | 2 layers PDSCH on 90% | 2 |
| | | of the slot | |
| 7 | 2 | 2 layers PDSCH on 10% | 1 (and RI |
| | | of the slot | report = 1) |

SNR = 0 db, PDSCH 256QAM

| | | | |
|---|---|---|---|
| 8 | 1 | 1 layers PDSCH on every | 2 |
| | | slot | |

It should be noted that the abovementioned description, steps, procedures and/or processes including suggested steps can be realized by means that could be hardware, software, firmware (known as a combination of a hardware device and computer instructions and data that reside as read-only software on the hardware device), an electronic system, or combination thereof. Examples of hardware can include analog, digital and mixed circuits known as microcircuit, microchip, or silicon chip. Examples of the communication system 1 may include a system on chip (SoC), system in package (SiP), a computer on module (CoM) and the computer system. Any of the abovementioned procedures and examples above may be compiled into program codes or instructions that are stored in a storage unit. The storage device 102 may include read-only memory (ROM), flash memory, random access memory (RAM), subscriber identity module (SIM), hard disk, or CD-ROM/DVD-ROM/BD-ROM, but not limited thereto. The processor 104 may read and execute the program codes or the instructions stored in the storage device 102 for realizing the abovementioned functions.

In summary, the communication device may adaptively adjust the antenna number of the first antennas to be used for the transmission with the network within the plurality of antennas according to the antenna selection information. In this way, the communication device of the present invention may perform the transmission with the network and consume less power.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication method, comprising:
generating, by a processor of a communication device having a plurality of antennas, an antenna selection information;
determining, by the processor, first antennas to be used for a transmission with a network within the plurality of antennas according to the antenna selection information; and
performing, by the processor, the transmission with the network through the first antennas.

2. The communication method of claim 1, wherein the antenna selection information comprises a first layer number of a physical downlink shared channel (PDSCH).

3. The communication method of claim 2, wherein determining the first antennas to be used for the transmission with the network comprises:
comparing the first layer number of the PDSCH with an antenna number of the first antennas;
maintaining the antenna number of the first antennas in an event that the antenna number of the first antennas is equal to the first layer number of the PDSCH; and
decreasing the antenna number of the first antennas in an event that the antenna number of the first antennas is greater than the first layer number of the PDSCH.

4. The communication method of claim 1, wherein the antenna selection information comprises a second layer number of a downlink (DL) maxLayersMIMO.

5. The communication method of claim 4, wherein determining the first antennas to be used for the transmission with the network comprises:
comparing the second layer number of the DL maxLayersMIMO with a receiver capability;
decreasing the antenna number of the first antennas in an event that the second layer number of the DL maxLayersMIMO is smaller than the receiver capability; and
requesting the network to decrease the second layer number of the DL maxLayersMIMO to be smaller than the receiver capability in an event that the second layer number of the DL maxLayersMIMO is not smaller than the receiver capability.

6. The communication method of claim 5, wherein requesting the network to decrease the second layer number of the DL maxLayersMIMO to be smaller than the receiver capability is through sending a fake rank indicator (RI) or a UE-assisted information (UAI) to the network.

7. The communication method of claim 1, wherein the antenna selection information comprises a PDCCH-only (physical downlink control channel) ratio and an average PHY throughput.

8. The communication method of claim 7, wherein determining the first antennas to be used for the transmission with the network comprises:
determining whether the communication device is in a light traffic state according to the PDCCH-only ratio and the average PHY throughput;
maintaining or increasing the antenna number of the first antennas in an event that the communication device is not in the light traffic state; and
decreasing the antenna number of the first antennas in an event that the communication device is in the light traffic state.

9. The communication method of claim 1, wherein the antenna selection information comprises at least one signal quality indicator of the communication device.

10. The communication method of claim 9, wherein determining the first antennas to be used for the transmission with the network comprises:
determining whether the at least one signal quality indicator of the communication device is in a poor state;
maintaining or increasing the antenna number of the first antennas in an event that the at least one signal quality of the communication device is in the poor state; and
decreasing the antenna number of the first antennas in an event that the at least one signal quality of the communication device is not in the poor state.

11. A communication device, comprising:
a plurality of antennas; and
a storage device, configured to store instructions of:
generating an antenna selection information;
determining first antennas to be used for a transmission with a network within the plurality of antennas according to the antenna selection information; and
performing the transmission with the network through the first antennas; and
a processor, coupled to the plurality of antennas and the storage device, configured to execute the instructions stored in the storage device.

12. The communication device of claim 11, wherein the antenna selection information comprises a first layer number of a physical downlink shared channel (PDSCH).

13. The communication device of claim 12, wherein determining the first antennas to be used for the transmission with the network comprises:
comparing the first layer number of the PDSCH with an antenna number of the first antennas;
maintaining the antenna number of the first antennas in an event that the antenna number of the first antennas is equal to the first layer number of the PDSCH; and
decreasing the antenna number of the first antennas in an event that the antenna number of the first antennas is greater than the first layer number of the PDSCH.

14. The communication device of claim 11, wherein the antenna selection information comprises a second layer number of a downlink (DL) maxLayersMIMO.

15. The communication device of claim 14, wherein determining the first antennas to be used for the transmission with the network comprises:
comparing the second layer number of the DL maxLayersMIMO with a receiver capability;
decreasing the antenna number of the first antennas in an event that the second layer number of the DL maxLayersMIMO is smaller than the receiver capability; and
requesting the network to decrease the second layer number of the DL maxLayersMIMO to be smaller than the receiver capability in an event that the second layer number of the DL maxLayersMIMO is not smaller than the receiver capability.

16. The communication device of claim 15, wherein requesting the network to decrease the second layer number of the DL maxLayersMIMO to be smaller than the receiver capability is through sending a fake rank indicator or a UE-assisted information to the network.

17. The communication device of claim 11, wherein the antenna selection information comprises a PDCCH-only ratio and an average PHY throughput.

18. The communication device of claim 17, wherein determining the first antennas to be used for the transmission with the network comprises:
determining whether the communication device is in a light traffic state according to the PDCCH-only ratio and the average PHY throughput;
maintaining or increasing the antenna number of the first antennas in an event that the communication device is not in the light traffic state; and
decreasing the antenna number of the first antennas in an event that the communication device is in the light traffic state.

19. The communication device of claim 11, wherein the antenna selection information comprises at least one signal quality indicator of the communication device.

20. The communication device of claim 19, wherein determining the first antennas to be used for the transmission with the network comprises:
determining whether the at least one signal quality indicator of the communication device is in a poor state;
maintaining or increasing the antenna number of the first antennas in an event that the at least one signal quality of the communication device is in the poor state; and
decreasing the antenna number of the first antennas in an event that the at least one signal quality of the communication device is not in the poor state.
